(19) United States
(12) Patent Application Publication
(10) Pub. No.: US 2017/0335692 A1
(43) Pub. Date: Nov. 23, 2017

(54) REFRACTORY METAL CORE AND COMPONENTS FORMED THEREBY

(71) Applicant: United Technologies Corporation, Farmington, CT (US)

(72) Inventors: Christopher King, Bristol, CT (US); Tracy A. Propheter-Hinckley, Manchester, CT (US); San Quach, East Hartford, CT (US)

(21) Appl. No.: 15/159,890

(22) Filed: May 20, 2016

(51) Int. Cl. F01D 5/18; F01D 9/02; F04D 29/32; F04D 29/54; F04D 29/58; F01D 25/08

(52) U.S. Cl. CPC F01D 5/187; F04D 29/582; F01D 25/08; F04D 29/324; F04D 29/542; F01D 9/02; F05D 2220/32; F05D 2230/211; F05D 2260/202; F05D 2300/13

(57) ABSTRACT

Refractory metal cores for manufacturing components of gas turbine engines, manufactured components, and related methods are provided. A refractory metal core includes a trunk configured to attach to a cavity core structure, a first branch extending from the trunk and configured to form a first portion of a cooling circuit in the component, and a second branch extending from the trunk and configured to form a second portion of the cooling circuit in the component. The first branch and the second branch are configured to define fluid exits at two different locations on an exterior of the component.

### BACKGROUND

The subject matter disclosed herein generally relates to gas turbine engine components and, more particularly, to refractory metal cores for manufacturing components of gas turbine engines.

Turbine engine components, such as turbine blades and vanes, are operated in high temperature environments. To avoid deterioration in the components resulting from their exposure to high temperatures, it is necessary to provide cooling circuits within the components. Turbine blades and vanes are subjected to high thermal loads on both the suction and pressure sides of their airfoil portions and at both the leading and trailing edges. The regions of the airfoils having the highest thermal load can differ depending on engine design and specific operating conditions.

Refractory metal core technology offers the potential to provide higher specific cooling passages for turbine components such as blade and vane airfoils and seals. Refractory metal core technology allows cooling circuits to be placed just under the surface of the airfoil through which cooling air flows and is expelled into the gaspath. Improved cooling circuits within turbine components may be advantageous.

### SUMMARY

According to one embodiment, a refractory metal core for manufacturing a component of a gas turbine engine is provided. The refractory metal core includes a trunk configured to attach to a cavity core structure, a first branch extending from the trunk and configured to form a first portion of a cooling circuit in the component, and a second branch extending from the trunk and configured to form a second portion of the cooling circuit in the component. The first branch and the second branch are configured to define fluid exits at two different locations on an exterior of the component.

In addition to one or more of the features described above, or as an alternative, further embodiments of the refractory metal core may include that the trunk comprises a first refractory metal core body and a second refractory metal core body that are attached to each other.

In addition to one or more of the features described above, or as an alternative, further embodiments of the refractory metal core may include that each branch is a portion of a respective refractory metal core body that is not attached to the other refractory metal core body.

In addition to one or more of the features described above, or as an alternative, further embodiments of the refractory metal core may include that the first refractory metal core body and the second refractory metal core body are attached by at least one of welding, gluing, forging, pressing, laser operations, or mechanical attachment.

In addition to one or more of the features described above, or as an alternative, further embodiments of the refractory metal core may include that at least one of the first refractory metal core body and the second refractory metal core body includes a plurality of openings configured to form a plurality of air disturbance features in the component.

In addition to one or more of the features described above, or as an alternative, further embodiments of the refractory metal core may include that the trunk has a first end configured to attach to the cavity core structure and a second end, wherein the first branch extends from the second end of the trunk and the second branch extends from the branch at a location between the first end and the second end.

In addition to one or more of the features described above, or as an alternative, further embodiments of the refractory metal core may include that the exit defined by the first branch is located on a first surface of the component and the exit defined by the second branch is located on a second surface of the component.

In addition to one or more of the features described above, or as an alternative, further embodiments of the refractory metal core may include that the first surface is a pressure side surface of the component and second surface is a suction side surface of the component.

In addition to one or more of the features described above, or as an alternative, further embodiments of the refractory metal core may include that the exit defined by the first branch is located on a first surface of the component at a first location and the exit defined by the second branch is located on the first surface of the component at a second location.

In addition to one or more of the features described above, or as an alternative, further embodiments of the refractory metal core may include that the exit defined by the first branch and the exit defined by the second branch are located on the same surface of the component

According to another embodiment, a component for a gas turbine engine is provided. The component includes a cavity formed inside the component and defining a cooling flow path within the component, and a cooling circuit fluidly connecting the cavity to an exterior of the component, wherein the cooling circuit comprises a first portion and a second portion wherein the first portion of the cooling circuit and the second portion of the cooling circuit are configured to define fluid exits at two different locations on the exterior of the component, and wherein the first portion and the second portion extend from a trunk portion of the cooling circuit.

In addition to one or more of the features described above, or as an alternative, further embodiments of the component may include that at least one of the trunk portion, the first portion of the cooling circuit, or the second portion of the cooling circuit includes a plurality of air disturbance features in the cooling circuit.

In addition to one or more of the features described above, or as an alternative, further embodiments of the component may include that the trunk portion has a first end fluidly adjacent the cavity and a second end, wherein the first portion of the cooling circuit extends from the second end of the trunk portion and the second portion extends from the branch portion at a location between the first end and the second end.

In addition to one or more of the features described above, or as an alternative, further embodiments of the component may include that the exit defined by the first portion of the cooling circuit is located on a first surface of the component and the exit defined by the second portion of the cooling circuit is located on a second surface of the component.

In addition to one or more of the features described above, or as an alternative, further embodiments of the component may include that the first surface is a pressure side surface of the component and second surface is a suction side surface of the component.

In addition to one or more of the features described above, or as an alternative, further embodiments of the component may include that the exit defined by the first portion of the cooling circuit is located on a first surface of the component at a first location and the exit defined by the second portion of the cooling circuit is located on the first surface of the component at a second location.

According to another embodiment, a method of manufacturing a component for a gas turbine engine is provided. The method includes forming a refractory metal core having a trunk configured to attach to a cavity core structure, a first branch extending from the trunk and configured to form a first portion of a cooling circuit in the component, and a second branch extending from the trunk and configured to form a second portion of the cooling circuit in the component, attaching the refractory metal core to a cavity core structure, and forming the component having an interior cavity based on the cavity core structure and a cooling circuit defined by the refractory metal core, the cooling circuit having a trunk portion defined by the trunk, a first portion defined by the first branch, and a second portion defined by the second branch. The first branch and the second branch are configured to define fluid exits at two different locations on an exterior of the component.

In addition to one or more of the features described above, or as an alternative, further embodiments of the method may include that forming the refractory metal core comprises attaching a first refractory metal core body and a second refractory metal core body to each other.

In addition to one or more of the features described above, or as an alternative, further embodiments of the method may include that the first refractory metal core body and the second refractory metal core body are attached by at least one of welding, gluing, forging, pressing, laser operations, or mechanical attachment.

In addition to one or more of the features described above, or as an alternative, further embodiments of the method may include that at least one of the first refractory metal core body and the second refractory metal core body includes a plurality of openings configured to form a plurality of air disturbance features in the component.

In addition to one or more of the features described above, or as an alternative, further embodiments of the method may include that the exit defined by the first branch is located on a first surface of the component and the exit defined by the second branch is located on a second surface of the component.

Technical effects of embodiments of the present disclosure include refractory metal cores for manufacturing components of gas turbine engines having a trunk and multiple branches extending therefrom. Further technical effects include components for gas turbine engines having a cavity and a branch portion of a cooling circuit extending therefrom with multiple branch portions of the cooling circuit extending from the trunk to define multiple, different exits on an exterior of the component.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic cross-sectional illustration of a gas turbine engine that may employ various embodiments disclosed herein;

FIG. 1B is a schematic illustration of a turbine that may employ various embodiments disclosed herein;

FIG. 2A is a cross-sectional illustration of an airfoil cast using the core assembly shown in FIG. 2B;

FIG. 2B is a perspective illustration of a core assembly used to form the airfoil of FIG. 2A;

FIG. 3A is a top-down schematic illustration of a refractory metal core in accordance with a non-limiting embodiment of the present disclosure;

FIG. 3B is a top-down schematic illustration of another refractory metal core in accordance with a non-limiting embodiment of the present disclosure;

FIG. 3C is a top-down schematic illustration of another refractory metal core in accordance with a non-limiting embodiment of the present disclosure;

FIG. 3D is a top-down schematic illustration of another refractory metal core in accordance with a non-limiting embodiment of the present disclosure;

FIG. 3E is a top-down schematic illustration of another refractory metal core in accordance with a non-limiting embodiment of the present disclosure;

FIG. 4A is a top-down schematic illustration of another refractory metal core in accordance with a non-limiting embodiment of the present disclosure;

FIG. 4B is a side elevation schematic illustration of the refractory metal core of FIG. 4A;

FIG. 5 is a cross-sectional illustration of a trailing edge of an airfoil formed using a refractory metal core in accordance with a non-limiting embodiment of the present disclosure;

FIG. 6 is a cross-sectional illustration of a trailing edge of another airfoil formed using a refractory metal core in accordance with a non-limiting embodiment of the present disclosure;

FIG. 7 is a cross-sectional illustration of an airfoil formed using a refractory metal core in accordance with a non-limiting embodiment of the present disclosure; and

FIG. 8 is a flow process for manufacturing a component of a gas turbine engine in accordance with a non-limiting embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

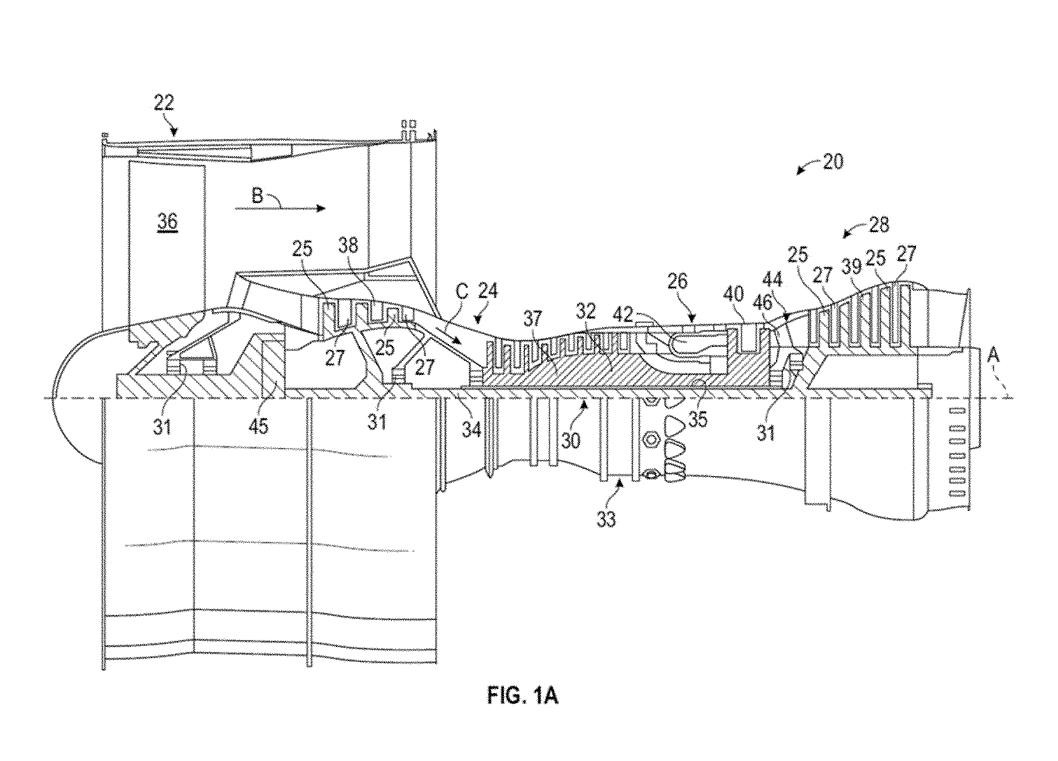

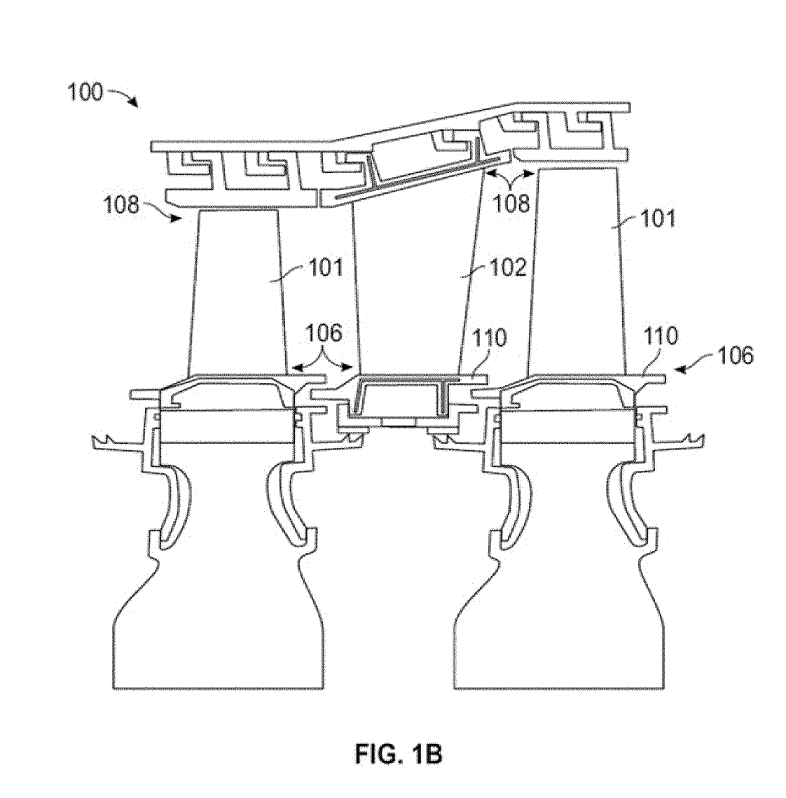

FIG. 1A schematically illustrates a gas turbine engine 20. The exemplary gas turbine engine 20 is a two-spool turbofan engine that generally incorporates a fan section 22, a compressor section 24, a combustor section 26, and a turbine section 28. Alternative engines might include an augmenter section (not shown) among other systems for features. The fan section 22 drives air along a bypass flow path B, while the compressor section 24 drives air along a core flow path C for compression and communication into the combustor section 26. Hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only examples of one embodiment of a geared architecture engine and that the present disclosure is applicable to other gas turbine engines, including direct drive turbofans.

In this embodiment of the example gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [(Tram ° R)/(518.7° R)]^{0.5}, where T represents the ambient temperature in degrees Rankine. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 of the rotor assemblies create or extract energy (in the form of pressure) from the core airflow that is communicated through the gas turbine engine 20 along the core flow path C. The vanes 27 of the vane assemblies direct the core airflow to the blades 25 to either add or extract energy.

Various components of a gas turbine engine 20, including but not limited to the airfoils of the blades 25 and the vanes 27 of the compressor section 24 and the turbine section 28, may be subjected to repetitive thermal cycling under widely ranging temperatures and pressures. The hardware of the turbine section 28 is particularly subjected to relatively extreme operating conditions. Therefore, some components may require internal cooling circuits for cooling the parts during engine operation. Example cooling circuits that include features such as airflow bleed ports are discussed below.

FIG. 1B is a schematic view of a turbine section that may employ various embodiments disclosed herein. Turbine 100 includes a plurality of airfoils, including, for example, one or more blades 101 and vanes 102. The airfoils 101, 102 may be hollow bodies with internal cavities defining a number of channels or cavities, hereinafter airfoil cavities, formed therein and extending from an inner diameter 106 to an outer diameter 108, or vice-versa. The airfoil cavities may be separated by partitions within the airfoils 101, 102 that may extend either from the inner diameter 106 or the outer diameter 108 of the airfoil 101, 102. The partitions may extend for a portion of the length of the airfoil 101, 102, but may stop or end prior to forming a complete wall within the airfoil 101, 102. Thus, each of the airfoil cavities may be fluidly connected and form a fluid path within the respective airfoil 101, 102. The blades 101 and the vanes may include platforms 110 located proximal to the inner diameter thereof. Located below the platforms 110 may be airflow ports and/or bleed orifices that enable air to bleed from the internal cavities of the airfoils 101, 102. A root of the airfoil may connected to or be part of the platform 110.

Although an aero or aircraft engine application is shown and described above, those of skill in the art will appreciate that airfoil configurations as described herein may be applied to industrial applications and/or industrial gas turbine engines, land based or otherwise.

As noted, turbine airfoils can operate in high temperature environments that, in some circumstances, may exceed the melting point of the material of the airfoil. In order to cool the airfoil, cooling air is passed through it from the compressor. The coolant travels through the airfoil cavities which are designed to promote convective heat transfer. The cooling air can then be discharged out the airfoil through cavity slots (e.g., exits). The air exiting the slots can form a film of cooler air along surfaces of the airfoil and thus shield the airfoil from incoming hot fluids (e.g., combustion gases).

In accordance with various embodiments of the present disclosure, discharge cooling air flows can be provided to or on multiple surfaces of an airfoil by using stack refractory metal cores (RMCs) during formation and/or manufacture of the airfoils. RMCs are a tool that makes a negative in the final airfoil body and the airfoil is produced from positive material. As provided herein, the cores can be bent in singular concepts, shapes, geometries, etc. and in multi-core configurations, the cores can be glued, pancaked, welded, brazed, mechanically joined, or otherwise joined to create a desired stack and/or airfoil cavity configuration.

Core stacks as provided herein can be optimized for heat transfer and desired flow characteristics through and along an airfoil. The component (e.g., an airfoil), in some embodiments, can be additive manufactured with the desired internal cavity and/or flow path geometries to allow discharge on more than one surface and/or at multiple locations on a single surface of the airfoil. Accordingly, advantageously, discharge of cooling air can be provided onto multiple surfaces of an airfoil thus improving convective and conductive heat transfer by utilizing a single cavity and reducing the number and complexity of multiple cores, resulting in efficient film cooling.

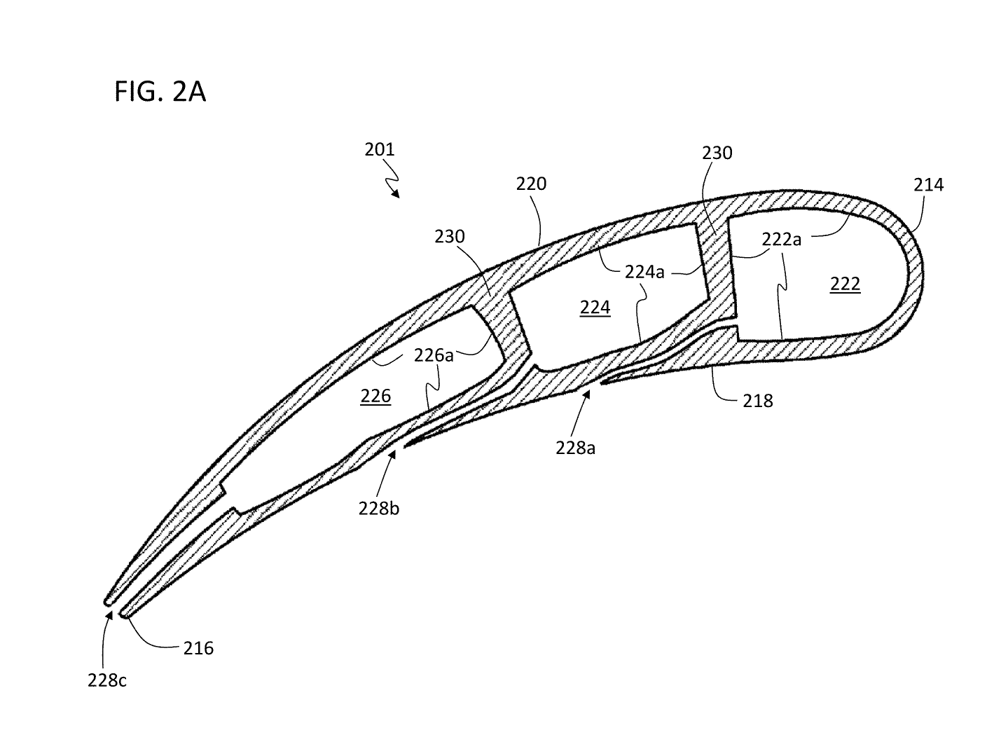

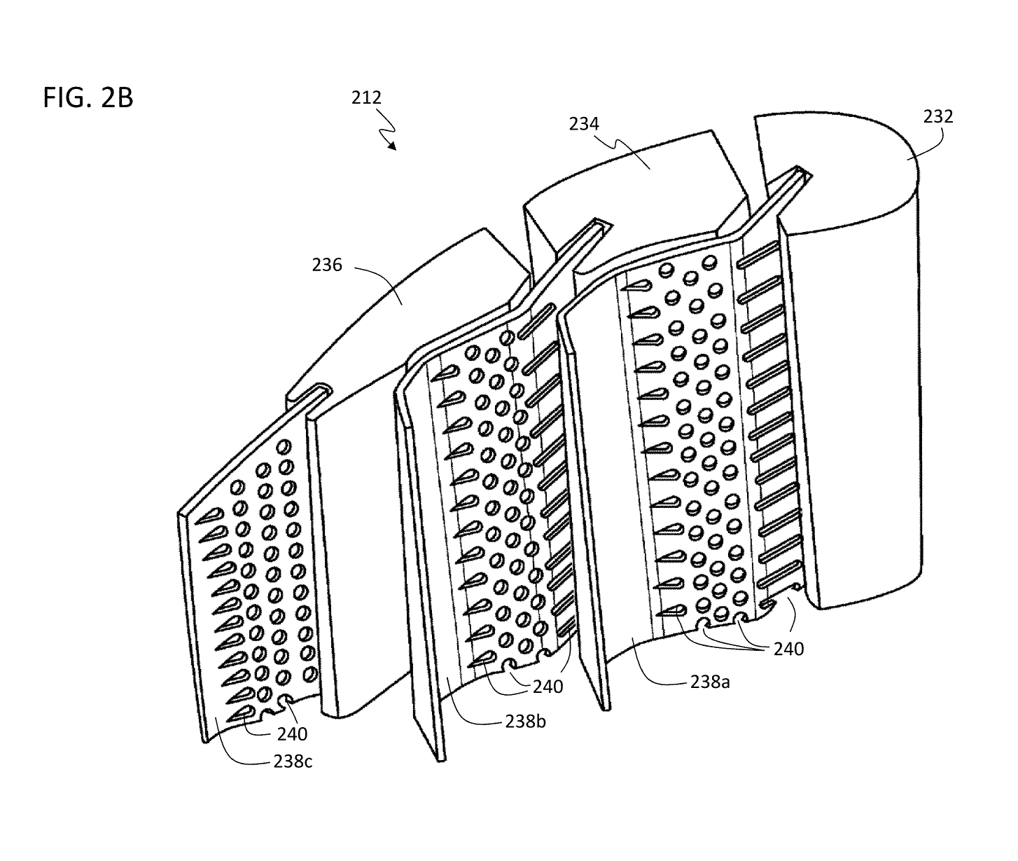

Turning now to FIGS. 2A and 2B, schematic illustrations of an airfoil (FIG. 2A) and a core (FIG. 2B) are shown. FIG. 2A is a cross-sectional illustration of an airfoil 201 cast using the core assembly 212 shown in FIG. 2B. FIG. 2B is a perspective illustration of the core assembly 212 used to form the airfoil 201 of FIG. 2A;

FIG. 2A illustrates a cross-sectional illustration of the airfoil 201 cast using the core assembly 212 illustrated in FIG. 2B. Airfoil 201 includes leading edge surface 214, trailing edge 216, pressure side surface 218, suction side surface 220, leading edge cavity 222, midchord cavity 224, trailing edge cavity 226, and cooling circuits 228a, 228b, and 228c. As a result of manufacturing process, leading edge cavity 222 is formed by a leading edge ceramic core, midchord cavity 224 is formed by a midchord ceramic core, and trailing edge cavity 226 is formed by a trailing edge ceramic core (see, e.g., FIG. 2B). Each cavity 222, 224, 226 is bounded by a respective cavity wall 222a, 224a, 226a. One or more ribs 230 separate the cavities 222, 224, 226. Each cooling circuit 228a, 228b, 228c is formed by an RMC (see FIG. 2B). As shown in FIG. 2A, cooling circuits 228a, 228b are positioned between a downstream cavity (e.g., 224, 226) and a side (e.g., pressure side surface 218) of airfoil 201.

As shown, cooling circuit 228a fluidly connects leading edge cavity 222 along a downstream portion of cavity wall 222a and extends between midchord cavity 224 and pressure side surface 218. As such, cooling fluid flowing through leading edge cavity 222 exits the cavity 222 and flows through cooling circuit 228a to cool the pressure side surface 218 of airfoil 201. Similarly, cooling circuit 228b joins with midchord cavity 224 along a downstream portion of cavity wall 224a and extends between trailing edge cavity 226 and pressure side surface 218. Cooling fluid exits midchord cavity 224 and flows through cooling circuit 228b to cool the pressure side surface 218 of airfoil 201 farther downstream of cooling circuit 228a. While FIG. 2A illustrates cooling circuits near the pressure side surface 218 of airfoil 201, cooling circuits can also be located between the cavities 222, 224, 226 and the suction side surface 220 of airfoil 201.

FIG. 2B illustrates a perspective view of one embodiment of a core assembly 212 for forming an airfoil 201. Core assembly 212 includes leading edge ceramic core 232, midchord ceramic core 234, and trailing edge ceramic core 236. A first refractory metal core (RMC) 238a is configured with the leading edge ceramic core 232, a second RMC 238b is configured with the midchord ceramic core 234, and a third RMC 238c is configured with the trailing edge ceramic core 236. The ceramic cores 232, 234, 236 are used to form inner passages (e.g., cavities 222, 224, 226) for cooling fluid within the airfoil 201. The RMCs 238a, 238b, 238c are used to form cooling circuits (e.g., a network of cooling passages including cooling circuits 228a, 228b, 228c) within the airfoil 201. The cooling circuits 228a, 228b, 228c in the cast airfoil 201 will receive cooling fluid from the inner passage(s) 222, 224, 226 with which they are fluidly connected. In order for the cooling circuits 228a, 228b, 228c in the cast airfoil 201 to receive cooling fluid from the inner passages 222, 224, 226, the ceramic cores 232, 234, 236 and the RMCs 238a, 238b, 238c are in contact with one another. RMCs 238a, 238b, 238c are secured to the appropriate ceramic core 233, 234, 236 to maintain contact during a casting process. In some embodiments, core assembly 212 can contain more than one midchord ceramic core 234 and associated downstream RMCs 238b.

Each of the RMCs 238a, 238b, 238c can include a plurality of openings 240, as shown. Once cast, openings 240 form a plurality of air disturbance features, include pedestals or other features, which direct cooling fluid through a respective cooling circuit 228a, 228b, 228c. Openings 240 can be circular, oblong, racetrack-shaped, teardrop-shaped, or any other shape depending on the flow control needs of the specific cooling circuit 228a, 228b, 228c. Although described above with respect to casting, those of skill in the art will appreciate that other manufacturing processes can be used without departing from the scope of the present disclosure. For example, additive manufacturing techniques can be used to form the structures and configurations of airfoils as provided herein.

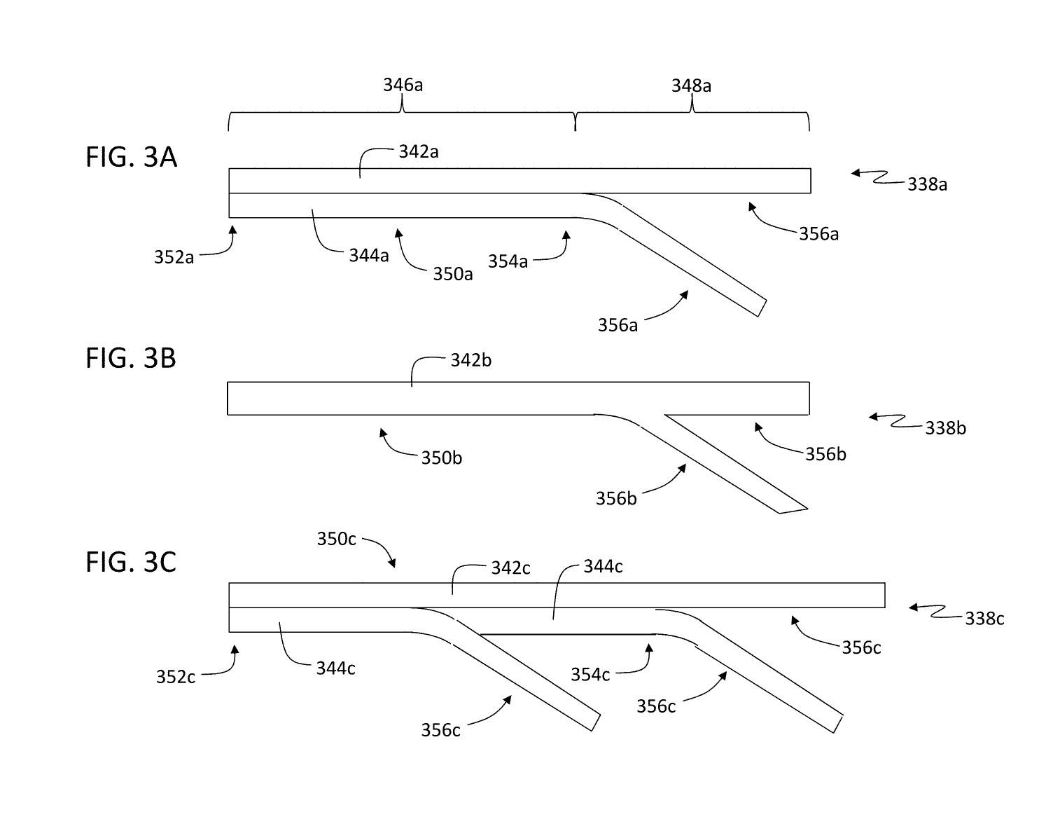

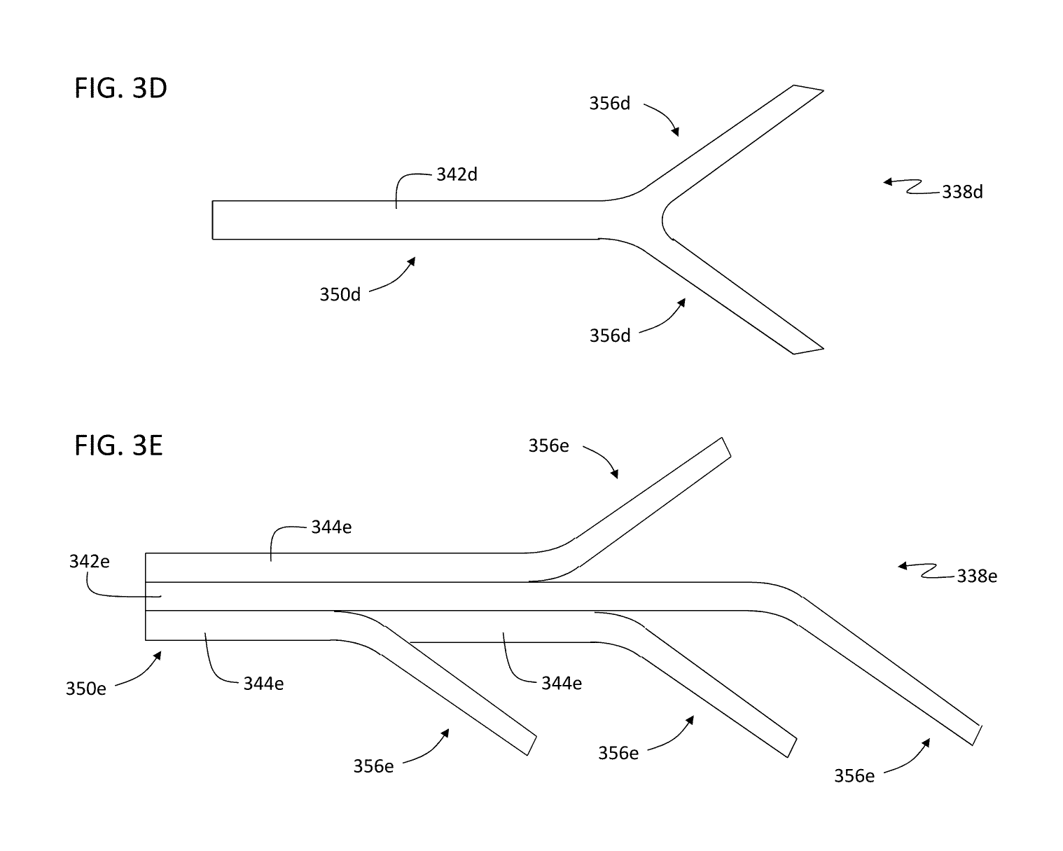

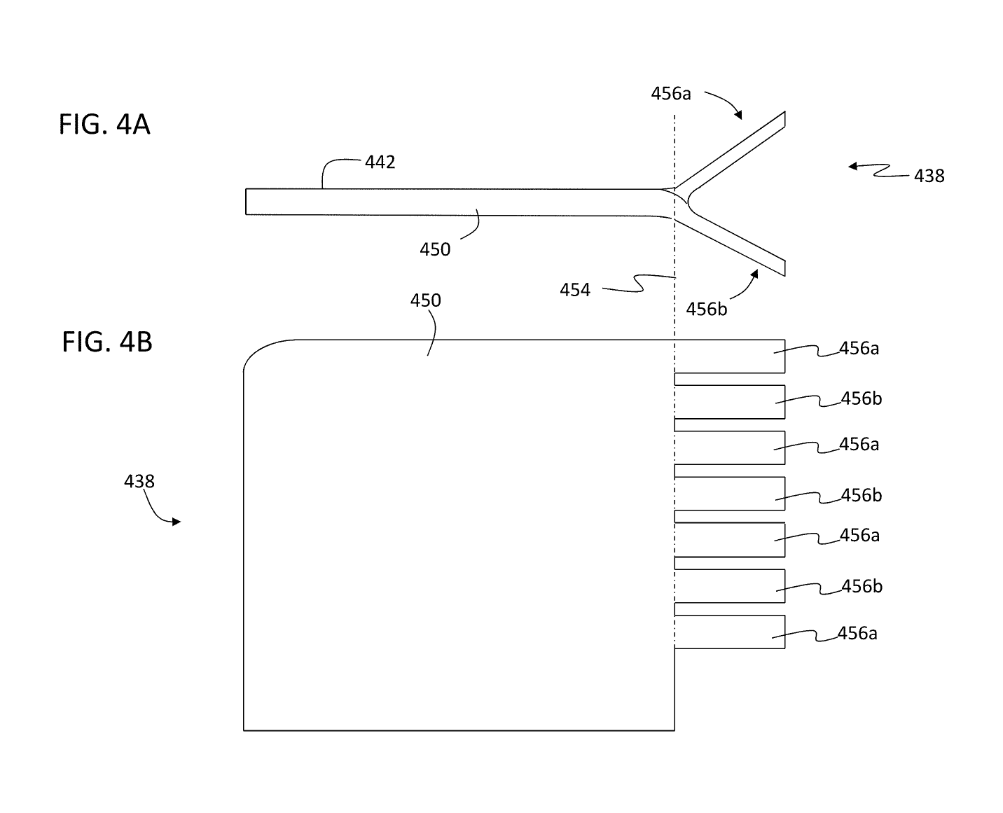

Turning now to FIGS. 3A-4B, schematic illustrations of RMCs in accordance with non-limiting embodiments of the present disclosure are shown. FIGS. 3A-3E are top-down illustrations of RMCs in various configurations. FIG. 4A is a top-down illustration of an RMC in accordance with a non-limiting embodiment and FIG. 4B is an elevational illustration of the RMC of FIG. 4A. The RMCs of FIGS. 3A-4B can be used with ceramic cores or other structures to define a positive structure of the internal cavities (i.e., negative space) within an airfoil, such as as described above.

FIG. 3A is a first illustration of an RMC 338a that is constructed of two RMC bodies that are attached together. For example, as shown, a first RMC body 342a and a second RMC body 344a are bonded together to form the RMC 338a, thus forming an RMC stack. The attachment between the first RMC body 342a and the second RMC body 344a can be by any known mechanism including, but not limited to, gluing, brazing, pancaking, welding (e.g., friction, heat, etc.), laser operations, forging, pressing, mechanical fixing, and/or other joining processes or mechanisms. Further, in some embodiments, the RMC bodies and/or the RMC can be additively manufactured.

The RMC 338a includes a first portion 346a and a second portion 348a. In the embodiment of FIG. 3A, the first portion 346a forms a trunk 350a that is defined as the portion or section of the RMC 338a where the first RMC body 342a and the second RMC body 344a are attached. The trunk 350a has a first end 352a and a second end 354a. The trunk 350a is a structure or portion of the RMC 338a that is configured to join with or attached to a ceramic core or other core structure used to form a cavity within an airfoil. The first end 352a of the trunk 350a is thus free to be engaged with or otherwise interact with a cavity core structure and the second end 354a is opposite therefrom.

The second portion 348a is defined by one or more branches 356a that extend from the trunk 350a where the first RMC body 342a and the second RMC body 344a are not joined or attached (i.e., are separated from each other). In this embodiment, the first RMC body 342a defines one branch 356a and the second RMC body 344a defines another branch 356a, each extending from the second end 354a of the trunk 350a.

During manufacture of an airfoil based on, in part, the RMC 338a, the trunk 350a will form a relatively wide cooling circuit that can extend from a cavity of the airfoil (e.g., as shown and described above). However, due to the configuration and structure of the RMC 338a, the cooling circuit can include multiple passages that extend to different locations and/or surfaces of the airfoil and thus provide cooling at multiple locations on the exterior of the airfoil. The multiple passages are based on the configuration of the branches 356a of the second portion 348a of the RMC 338a.

FIG. 3B shows another configuration of an RMC 338b in accordance with an embodiment of the present disclosure. The RMC 338b is substantially similar to the RMC 338a of FIG. 3A and forms a similar cooling circuit in a manufactured airfoil. However, as shown in FIG. 3B, the RMC 338b is a unitary or single RMC body 342b. In this case, a trunk 350b is a portion of the single RMC body 342b and the branches 356b extend therefrom, with each branch 356b part of the single RMC body 342b. The trunk 350b is the portion of the RMC 338b that is configured to connect to or join with a ceramic core or other core structure that is used to form cavities of an airfoil.

FIG. 3C shows another configuration of an RMC 338c in accordance with an embodiment of the present disclosure. In this embodiment, a first RMC body 342c and multiple second RMC bodies 344c are connected on one side of the first RMC body 342c. In this configuration, a trunk 350c has multiple branches 356c extending therefrom. As shown, one of the branches 356c extends from a point between a first end 352c and a second end 354c of the trunk 350c. In an alternative configuration, the two second RMC bodies 344c shown in FIG. 3C can be formed as a single, second RMC body without departing from the scope of the present disclosure.

FIG. 3D shows another configuration of an RMC 338d in accordance with an embodiment of the present disclosure. The RMC 338d of FIG. 3D is a unitary, single RMC body 342d with a trunk 350d and multiple branches 356d extending from the trunk 350d. As shown in the embodiment of FIG. 3D, the branches 356d extend at different angles and form a “Y” configuration with the trunk 350d.

FIG. 3E shows another configuration of an RMC 338e in accordance with an embodiment of the present disclosure. FIG. 3E illustrates that multiple second RMC bodies 344e can be attached to a first RMC body 342e. As shown, one second RMC body 344e is attached on a first side of the first RMC body 342e and multiple second RMC bodies 344e are attached on a second (and opposite) side of the first RMC body 342e. The trunk 350e is defined as any section of the RMC 338e where different RMC bodies 342e, 344e are attached. As shown, the branches 356e can extend from the trunk 350e from multiple locations along the length of the trunk 350e.

Turning now to FIGS. 4A-4B, another configuration of an RMC 438 in accordance with an embodiment of the present disclosure is shown. FIG. 4A shows a top-down illustration of the RMC 438 and FIG. 4B shows an elevational illustration of the RMC 438. As shown, the RMC 438 includes a single RMC body 442 defining a trunk 450 and a plurality of branches 456a, 456b extending therefrom. A first set of branches 456a are configured to extend in a first direction relative to the trunk 450 and a second set of branches 456b are configured to extend in a second direction relative to the trunk 450. As shown, each branch 456a, 456b is angled from a second end 454 of the trunk 450 (as illustrated by the dashed line in FIGS. 4A-4B). In the embodiment of FIGS. 4A-4B, the two sets of branches 456a, 456b are shown alternating in configuration. However, those of skill in the art will appreciate that any pattern or configuration of branches can be employed without departing from the scope of the present disclosure.

Those of skill in the art will appreciate that various alternative configurations and/or geometries are enabled by the present disclosure. Further, several of the above described embodiments can be combined and/or altered to form a desired cooling circuit within an airfoil. In some embodiments, a portion of the trunk (e.g., where at least two RMC bodies are joined) can extend the full length of the RMC, such that a wider cooling circuit passageway can be formed for the length of the trunk. Additionally, in some configurations, the trunk can bend, turn, or otherwise have a different geometry than a relatively straight line/body, as shown above.

Further, in some embodiments, one or more of the RMC bodies used to form the RMC of the present disclosure can include openings (e.g., openings 240 of FIG. 2B) to form a plurality of pedestals or other features that direct cooling fluid through a respective cooling circuit. The openings can be circular, oblong, racetrack-shaped, teardrop-shaped, or any other shape. Further, in some embodiments, two joined RMC bodies can be configured to matching or aligning openings. Moreover, in some embodiments, one RMC body can include openings while the other RMC body does not include openings, thus forming a unique interior structure to the cooling circuits when the airfoil is formed from the RMC. Still further, multiple of the RMC bodies can be configured with openings that don't align, or some openings that align and other that do not, thus enabling unique pedestal structures and/or configurations.

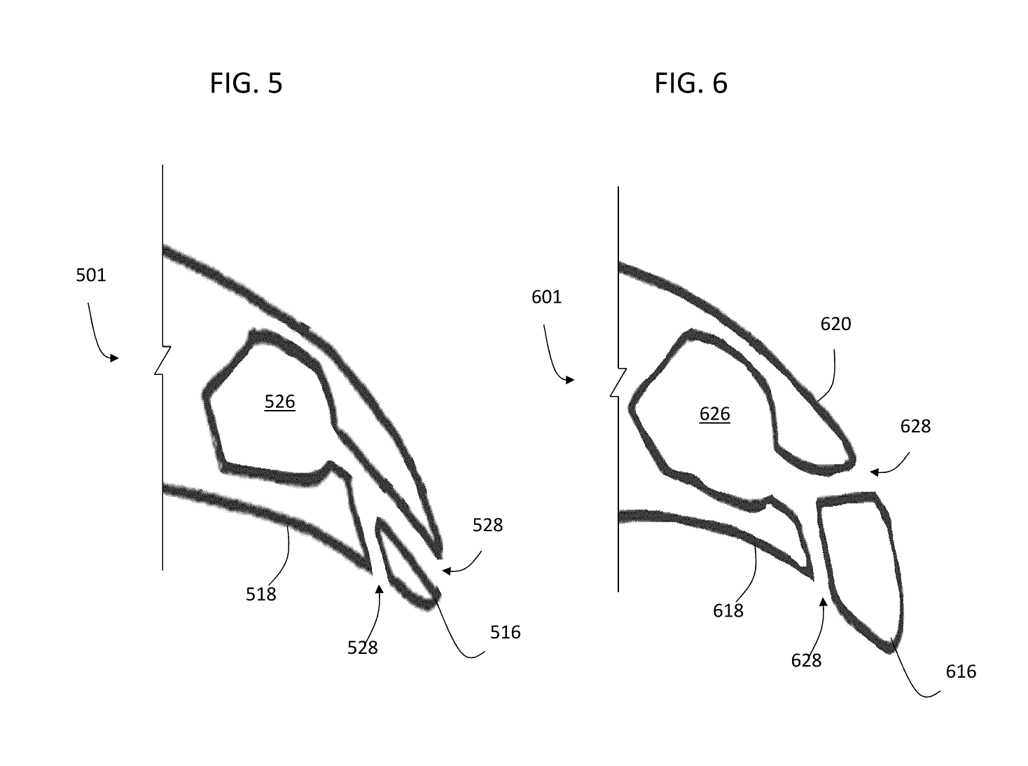

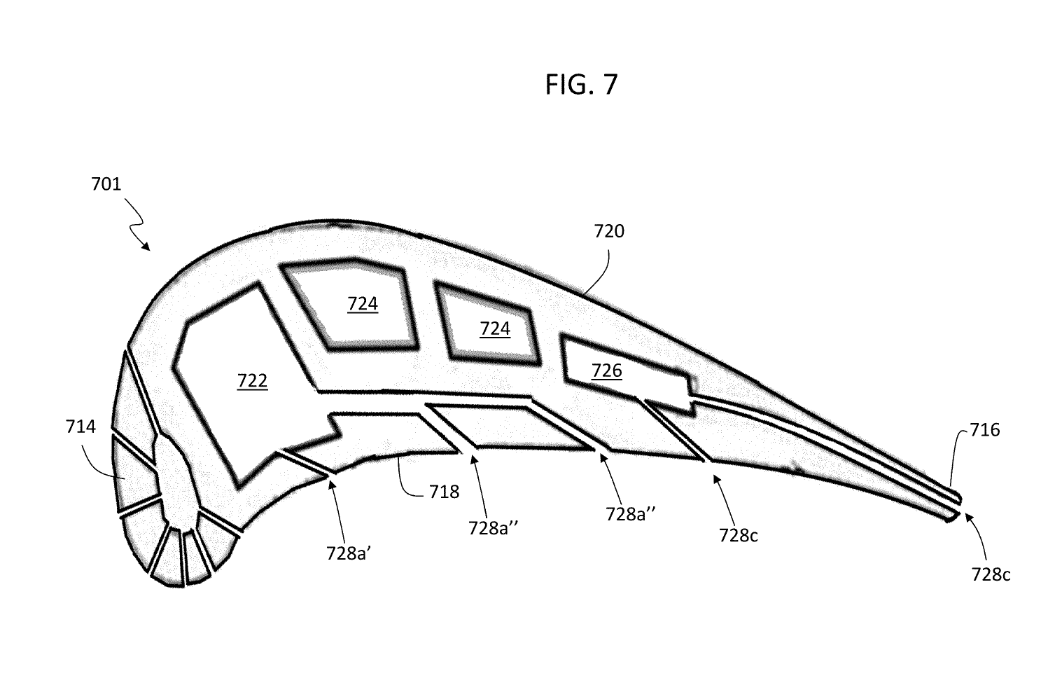

Turning now to FIGS. 5-7, schematic illustrations of airfoils formed with RMCs as provided herein are shown. FIGS. 5-6 each show a trailing edge of respective airfoils and FIG. 7 shows an airfoil extending from a leading edge to a trailing edge. Each of FIGS. 5-7 is a cross-sectional, top-down view of the interior structure of the respective airfoils.

With reference to FIG. 5, airfoil 501 includes a trailing edge cavity 526 that is fluidly connected to exterior surfaces of the airfoil 501 by cooling circuit 528. As shown, cooling circuit 528 has two exits with one exit configured near the trailing edge 516 but being open on a pressure side surface 518. The other of the exits of the cooling circuit 528 is formed in the trailing edge 516 of the airfoil 501. The airfoil 501 is manufactured using at least one RMC similar to that shown and described above. For example, the configuration and geometry of the cooling circuit 528 of FIG. 5 could be formed using an RMC similar to that shown in either FIG. 3A or FIG. 3B. As shown, the trunk of the RMC would be connected to a ceramic core that forms the trailing edge cavity 526, and the branches of the RMC would extend toward the trailing edge.

FIG. 6 shows an alternative configuration of a trailing edge 616 of an airfoil 601 in accordance with an embodiment of the present disclosure. The airfoil 601 includes a trailing edge cavity 626 with a cooling circuit 628 extending from the trailing edge cavity 626 toward the trailing edge 616. However, in this embodiment, as shown, the cooling circuit 628 has two exits that open onto each of the pressure surface side 618 and the suction surface side 620. The cooling circuit 628 can be formed, for example, by an RMC similar to that shown in FIG. 3D.

Turning now to FIG. 7, an airfoil 701 is shown. The airfoil 701 extends from a leading edge 714 to a trailing edge 716. As shown, the airfoil 701 includes a leading edge cavity 722, two midchord cavities 724, and a trailing edge cavity 726. The trailing edge cavity 726 includes two separate cooling circuits 728c, with one exiting onto a pressure side surface 718 and one exiting at the trailing edge 716. Further, as shown in the embodiment of FIG. 7, the airfoil 701 does not include any cooling circuits connected to the midchord cavities 724, although those of skill in the art will appreciate that cooling circuits could be formed therewith (e.g., fluidly exiting from the midchord cavities 724 to a suction side surface 720.

The leading edge cavity 722 includes multiple cooling circuits 728a. As shown, a first cooling circuit 728a′ can connect the leading edge cavity 722 to the pressure side surface 718 by a single passaged cooling circuit. Additionally, the leading edge cavity 722 is fluidly connected to the pressure side surface 718 by a second cooling circuit 728a″ that is formed by an RMC in accordance with the present disclosure. As shown, the second cooling circuit 728a″ has a larger section near the leading edge cavity 722 (e.g., formed by the trunk of the RMC) and two separate exits exiting onto the pressure surface side 718 (e.g., each formed by a branch of the RMC).

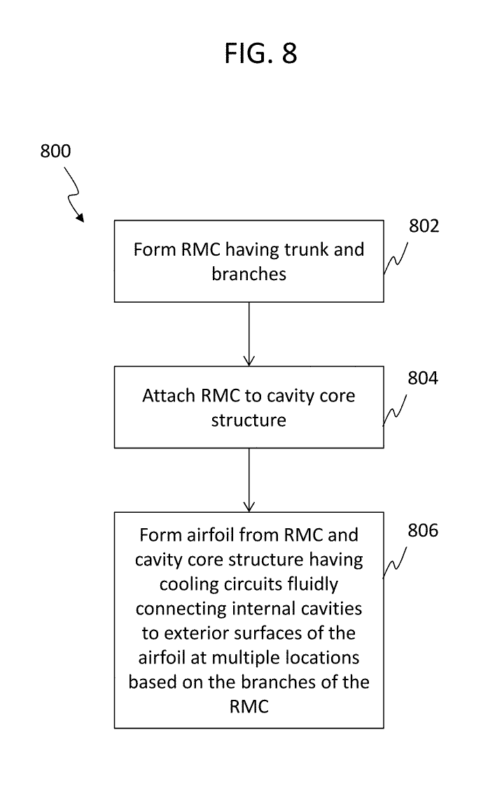

Turning now to FIG. 8, a flow process for forming or manufacturing an airfoil having cooling circuits as shown and described above is shown. The flow process 800 involves a casting process for the airfoil based on ceramic cores and RMCs. However, alternative manufacturing techniques can be used to form an airfoil having internal structures and/or configurations as described herein. Thus, the flow process 800 is not intended to be limiting, but rather is provided for illustrative purposes.

At block 802, an RMC having a trunk and branches formed thereon is formed. In some configurations, the formation of the RMC can be by additive manufacturing, with the trunk and branches integrally formed in a single piece or component. In other embodiments, the formation of the RMC can involve attaching or joining multiple RMC bodies to form the RMC having a trunk at the portions where at least two RMC bodies are joined or attached and branches where an RMC body is not attached to another RMC body. The attachment or joining of the RMC bodies can be by any known means and can include welding, gluing, laser operations, mechanically fixing, etc. In some configurations, a branch (as described above) can be attached to another RMC body and the trunk can be a portion of the RMC body that is configured to interact with a cavity core structure, as shown and described above. In some embodiments, the branches can be formed by bending a portion or portions of the RMC body (e.g., as shown in FIGS. 4A-4B).

The RMC can then be attached to a cavity core structure, as shown at block 804. In some embodiments, the cavity core structure may be a ceramic core. The attachment between the RMC and the cavity core structure may be by any means, as will be appreciated by those of skill in the art.

At block 806, an airfoil can be formed from the RMC and cavity core structure. The formed airfoil includes cooling circuits fluidly connecting internal cavities to exterior surfaces of the airfoil at multiple locations based on the branches of the RMC. That is, the cavity core structure can form the internal cavities and the RMC (trunk and branches) can form the cooling circuits, as shown and described herein.

Advantageously, embodiments described herein can provide improved high temperature applications for airfoil. For example, using RMCs as provided herein can be employed to optimize pressure side film cooling, while allowing for a more conventional serpentine cavity (e.g., midchord cavities) to be dedicated on the suction side of the airfoil.

The double-stack RMC of some embodiments provided herein can be configured to provide superposition of slot film effectiveness on the pressure side of the airfoil and greatly benefit the trailing edge temperatures. Further, multiple RMC insertions into the ceramic cores can be minimized. That is, RMCs as provided herein can be joined to a ceramic core at a single location (e.g., single trunk) and still provide multiple exits (e.g., branches) at various locations on the exteriors surfaces of the airfoil.

Further, advantageously, embodiments provided herein can provide cooling discharge on pressure side, suction side, trailing edge, top and/or bottom platform, and/or combinations thereof. That is, advantageously, cooling flow is enabled on multiple sides of a component from a single internal cavity of the component. Advantageously, such cooling can enable product life improvement which can decrease product life cycle costs.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although shown and described with respect to airfoils (e.g., vanes and blades) embodiments provided herein can be used in the manufacture of blade outer air seals, combustor panels, or other components that employ fluid cooling. Moreover, although primarily described with respect to conventional casting, additive manufacturing and machining methods can be used without departing from the scope of the present disclosure.

Accordingly, the present disclosure is not to be seen as limited by the foregoing description, but is only limited by the scope of the appended claims.

What is claimed is:

1. A refractory metal core for manufacturing a component of a gas turbine engine, the refractory metal core comprising:
a trunk configured to attach to a cavity core structure;
a first branch extending from the trunk and configured to form a first portion of a cooling circuit in the component; and
a second branch extending from the trunk and configured to form a second portion of the cooling circuit in the component,
wherein the first branch and the second branch are configured to define fluid exits at two different locations on an exterior of the component.

2. The refractory metal core of claim 1, wherein the trunk comprises a first refractory metal core body and a second refractory metal core body that are attached to each other.

3. The refractory metal core of claim 2, wherein each branch is a portion of a respective refractory metal core body that is not attached to the other refractory metal core body.

4. The refractory metal core of claim 2, wherein the first refractory metal core body and the second refractory metal core body are attached by at least one of welding, gluing, forging, pressing, laser operations, or mechanical attachment.

5. The refractory metal core of claim 2, wherein at least one of the first refractory metal core body and the second refractory metal core body includes a plurality of openings configured to form a plurality of air disturbance features in the component.

6. The refractory metal core of claim 1, wherein the trunk has a first end configured to attach to the cavity core structure and a second end, wherein the first branch extends from the second end of the trunk and the second branch extends from the branch at a location between the first end and the second end.

7. The refractory metal core of claim 1, wherein the exit defined by the first branch is located on a first surface of the component and the exit defined by the second branch is located on a second surface of the component.

8. The refractory metal core of claim 7, wherein the first surface is a pressure side surface of the component and second surface is a suction side surface of the component.

9. The refractory metal core of claim 1, wherein the exit defined by the first branch is located on a first surface of the component at a first location and the exit defined by the second branch is located on the first surface of the component at a second location.

10. The refractory metal core of claim 1, wherein the exit defined by the first branch and the exit defined by the second branch are located on the same surface of the component

11. A component for a gas turbine engine comprising:
a cavity formed inside the component and defining a cooling flow path within the component; and
a cooling circuit fluidly connecting the cavity to an exterior of the component, wherein the cooling circuit comprises a first portion and a second portion wherein the first portion of the cooling circuit and the second portion of the cooling circuit are configured to define fluid exits at two different locations on the exterior of the component, and wherein the first portion and the second portion extend from a trunk portion of the cooling circuit.

12. The component of claim 11, wherein at least one of the trunk portion, the first portion of the cooling circuit, or the second portion of the cooling circuit includes a plurality of air disturbance features in the cooling circuit.

13. The component of claim 11, wherein the trunk portion has a first end fluidly adjacent the cavity and a second end, wherein the first portion of the cooling circuit extends from the second end of the trunk portion and the second portion extends from the branch portion at a location between the first end and the second end.

14. The component of claim 11, wherein the exit defined by the first portion of the cooling circuit is located on a first surface of the component and the exit defined by the second portion of the cooling circuit is located on a second surface of the component.

15. The component of claim 14, wherein the first surface is a pressure side surface of the component and second surface is a suction side surface of the component.

16. The component of claim 11, wherein the exit defined by the first portion of the cooling circuit is located on a first surface of the component at a first location and the exit defined by the second portion of the cooling circuit is located on the first surface of the component at a second location.

17. A method of manufacturing a component for a gas turbine engine, the method comprising:
forming a refractory metal core having a trunk configured to attach to a cavity core structure, a first branch extending from the trunk and configured to form a first portion of a cooling circuit in the component, and a second branch extending from the trunk and configured to form a second portion of the cooling circuit in the component;
attaching the refractory metal core to a cavity core structure; and
forming the component having an interior cavity based on the cavity core structure and a cooling circuit defined by the refractory metal core, the cooling circuit having a trunk portion defined by the trunk, a first portion defined by the first branch, and a second portion defined by the second branch,
wherein the first branch and the second branch are configured to define fluid exits at two different locations on an exterior of the component.

18. The method of claim 17, wherein forming the refractory metal core comprises attaching a first refractory metal core body and a second refractory metal core body to each other.

19. The method of claim 17, wherein at least one of the first refractory metal core body and the second refractory metal core body includes a plurality of openings configured to form a plurality of air disturbance features in the component.

20. The method of claim 17, wherein the exit defined by the first branch is located on a first surface of the component and the exit defined by the second branch is located on a second surface of the component.
